(19) United States
(12) Patent Application Publication
(10) Pub. No.: US 2002/0016279 A1
(43) Pub. Date: Feb. 7, 2002

(54) Enzymatic oxidation composition and process

(75) Inventors: Daniel Convents, Vlaardingen (NL); Monique Doornink, Vlaardingen (NL); Monique van der Heiden, Vlaardingen (NL); Jean Hypolities Koek, Vlaardingen (NL); Richard George Smith, Vlaardingen (NL); David William Thornthwaite, Bebington (GB); Sebastiaan van der Velden, Vlaardingen (NL); Cornelis Hendrikus de Vries, Vlaardingen (NL); Nicole Zwets, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/864,941

(22) Filed: May 24, 2001

(30) Foreign Application Priority Data
May 31, 2000 (EP) 00201959.4
Oct. 31, 2000 (EP) 00309607.0

(51) Int. Cl. C11D 3/00; C11D 3/386

(52) U.S. Cl. 510/392; 510/530

(57) ABSTRACT

There is provided an enzymatic oxidation composition and process wherein an oxidisable substance is reacted with (a) a peroxidase, (b) a compound which enhances the activity of the peroxidase and (c) molecular oxygen, said composition being essentially free from hydrogen peroxide and compounds capable of generating hydrogen peroxide. The process is useful in detergent compositions for stain bleaching and/or anti dye-transfer.

### TECHNICAL FIELD

The present invention generally relates to an enzymatic oxidation composition and process. More in particular, it relates to an enzymatic oxidation process wherein an oxidisable substance is reacted with a peroxidase in the presence of a compound which enhances the oxidation reaction. The invention especially relates to a process and composition for enzymatic laundry bleaching.

### BACKGROUND AND PRIOR ART

Peroxidases are enzymes which utilize hydrogen peroxide to oxidize certain oxidisable substrates. In “Enzyme Nomenclature 1978, IUB”, Academic Press, New York, San Francisco, London (1979), they are classified in class 1.11.1.7. Several applications of peroxidases in oxidative processes have been described. Such applications include, amongst others, stain bleaching and anti dye-transfer in detergents, polymerization of lignin, in-situ depolymerization of lignin in Kraft pulp, bleaching of denim dyed garments, polymerization of phenolic substances in juices and beverages and hair bleaching (WO-A-92/18683, WO-A-95/07988, WO-A-95/01426).

WO-A-89/09813 (Novo Nordisk) discloses enzymatic bleaching compositions comprising a source of hydrogen peroxide and a peroxidase and WO-A-91/05839 (Novo Nordisk) discloses enzymatic anti dye-transfer compositions comprising an (a) an enzyme exhibiting peroxidase activity and a source of hydrogen peroxide, or (b) an enzyme exhibiting oxidase activity on phenolic compounds. The compositions are said to bleach any dissolved dye so that no dye can redeposit upon the fabric.

Characteristic to peroxidases is that they have little substrate specificity. Most small phenolic molecules can be oxidised by these enzymes. The range of molecules which can be oxidized by these enzymes can be extended by the addition of so-called enhancers. These molecules are then the primary substrate for the enzymes. Upon reaction with the enzyme, the enhancers are oxidized to generate radicals which subsequently oxidize the final substrate of interest.

Several classes of molecules have been described as enhancers for peroxidases. Among these are simple substituted phenols, benzidine derivatives, phenothiazine derivatives, and azino compounds (WO-A-94/12619, WO-A-94/12620 and WO-A-94/12621, all Novo Nordisk). The value of these enhancers has been demonstrated in anti dye-transfer compositions for detergents.

Although these and several other enzymatic bleach systems have been proposed, there is still a need for alternative or improved enzymatic bleach systems. For laundry applications in particular, the enzymatic bleach system should be capable of bleaching stains which are otherwise difficult to remove, the so-called “problem stains” such as tomato, tea, blackberry juice, or red wine. Another important aspect is that the enzymatic bleach system should deliver its benefit at an economically attractive price.

We have now surprisingly found that it is possible to oxidize oxidisable substrates by means of peroxidase, an enhancer and molecular oxygen. In other words, we found that peroxidase can utilise molecular oxygen without the need for hydrogen peroxide to be added to the reaction system. This is surprising, because until now the presence of hydrogen peroxide in reaction systems involving peroxidases was generally thought to be essential.

### DEFINITION OF THE INVENTION

According to a first aspect of the invention, there is provided an enzymatic oxidation process wherein an oxidisable substance is reacted with (a) a peroxidase, (b) a compound which enhances the activity of the peroxidase and (c) molecular oxygen.

According to a second aspect, there is provided an enzymatic composition for stain bleaching and/or anti dye-transfer, comprising: (a) a peroxidase and (b) a compound which enhances the activity of the peroxidase, said composition being essentially free from hydrogen peroxide and compounds capable of generating hydrogen peroxide.

### DESCRIPTION OF THE INVENTION

In a first aspect, the invention relates to an enzymatic oxidation process wherein an oxidisable substance is reacted with (a) peroxidase and (b) a compound which enhances the oxidation activity of the enzyme and (c) molecular oxygen. The oxidation process can be used within a detergent composition, specifically suited for stain bleaching and/or dye transfer prevention purposes, and this constitutes a second aspect of the invention. The detergent composition may take any suitable physical form, such as a powder, an aqueous or non aqueous liquid, a paste or a gel.

(a) The Peroxidase

The enzymatic oxidation composition according to the invention comprises, as a first constituent, a peroxidase. A peroxidase is defined for the purpose of this invention as en enzyme having peroxidase activity, i.e. an enzyme capable of catalysing those enzymatic reactions that result in the oxidation of organic compounds, whereby hydrogen peroxide acts as the electron acceptor. Examples of such organic compounds are 2,2′Azinobis(3-ethyl benzo thiazoline-6-sulfonic acid ammonium salt (ABTS), guiacol, syringaldazine, or phenothiazine-10-propionic acid. Suitable examples of peroxidases are the enzymes of EC 1.11.1, in particular any peroxidase comprised by the enzyme classification EC 1.11.1.7; peroxidase fragments exhibiting peroxidase activity, as well as synthetic and semi-synthethic peroxidase derivatives (e.g. pophyrin ring systems), or microperoxidases (see U.S. Pat. No. 4,077,768, EP-A-537 381, WO-A-91/05858 and WO-A92/16634) are also relevant in the context of the invention. Also suitable can be transition metal complexes that display peroxidase activity.

An important aspect of the present invention is that the peroxidase (the compound that displays peroxidase activity) is added to a bleaching composition, without the addition of peroxide.

Suitable peroxidases are disclosed in EP-A-495 835 and EP-A-424 398 (both Novo Nordisk). For instance, suitable peroxidases may be isolated from and are producible by plants or microorganisms such as bacteria or fungi. Preferred fungi are strains belonging to the class of the Basidiomycetes, in particular Coprinus, or to the class of Hyphomycetes, in particular Arthromyces, especially Arthromyces ramosus. Other preferred sources are Hormographiella sp., Myxococcus sp., Corallococcus sp. (WO-A-95/11964), or Soybean peroxidase.

Another group of suitable peroxidases are haloperoxidases, such as chloroperoxidase or bromo-peroxidase, lignine peroxidase, and manganese peroxidase. Also useful are lipoxygenases. A further useful class of peroxidases are catalases. This class of enzymes react with hydrogen peroxide, with the concomitant release of oxygen. Catalases can also be used in the present invention, without the addition of a peroxide source.

Especially useful is a peroxidase which is commercially available from Novo Nordisk as Guardzyme™. Also of interest are the enzyme engineered variants of peroxidase enzymes, as described in U.S. Pat. Nos. 5,968,883, 5,817,495, and WO-A-93/24618.

The enzymatic oxidation reaction of the present invention is carried out in a liquid medium, preferably an aqueous medium. The enzymatic oxidation compositions of the invention comprise about 0.001 to 10 milligrams of active enzyme per liter. A detergent composition will comprise about 0.001% to 1% of active enzyme (w/w). The enzyme activity can be expressed as ABTS (2,2′-azino-bis(3-ethylbenzothiazoline-6-sulphonic acid)units. The enzyme activity which is added to the enzymatic oxidation composition will be about 10 to 10⁶ ABTS units per liter, preferably 10³ to 10⁵ ABTS units per liter.

The enzymes used in the present invention can usefully be added to the detergent composition in any suitable form, i.e. the form of a granular composition, a liquid or a slurry of the enzyme, or with carrier material (e.g. as in EP-A-258 068 and the Savinase (™) and Lipolase (™) products of Novo Nordisk). Specific peroxidase granules have been described in WO-A-97/31088. A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

(b) The Source of Molecular Oxygen

Another ingredient of the bleaching process according to the invention is a source of molecular oxygen. Obviously, the most preferable source of molecular oxygen is air, as this is abundantly available. Alternatively, one may employ a molecular oxygen liberating system. The enzymatic oxygen-generating system may in principle be chosen from the various oxygen-generating systems which have been disclosed in the art. For example, one may use catalase enzymes, that generate oxygen from hydrogen peroxide.

C. The Enhancer

The novel oxidation process according to the present invention is based on the presence of a further compound, the peroxidase enhancer. The enzymatic oxidation composition will comprise about 0.1 μM to 10 mM of the enhancer compound, preferably between 1 μM and 1 mM, most preferably between 10 μM and 200 μM.

Several classes of peroxidase or oxidase enhancers have been described, see U.S. Pat. Nos. 5,700,769, 5,965,510, WO-A-94/12620, WO-A-95/01426 and WO-A-96/10079. Particular interest has been directed to the enhancer phenothiazine-10-propionate, as described in U.S. Pat. Nos. 5,451,337 and 5,445, 755. However, the described classes of enhancers only enhance the peroxidase activity when hydrogen peroxide is added to the bleaching composition.

The enhancers of the current invention, however, enhance the bleaching activity of the peroxidase enzyme, with the addition of molecular oxygen. In other words, when using the enhancers according to the invention, hydrogen peroxide does not need to be present for obtaining the desired enhancement of the oxidizing activity of peroxidases.

Several classes of compounds can be envisaged which deliver the capability of enhancing the peroxidase activity, in the presence of only oxygen. In the following we will give a number of examples of such compounds having such capabilities, without pretending to be exhaustive.

The enhancer can have the formula:

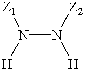

wherein:

wherein Z₁ is any organic group e.g. (substituted)-(hetero)-(polycyclic)-aromatic, substituted (cyclo)-alkyl containing hetero atoms, and Z₂ is electron withdrawing group (as described in J. March, 'Advanced Organic Chemistry, pg 17, 3d ed. (1985)), selected from the group consisting of optionally substituted alkyl/(hetero)aryl- -sulfone, -sulfoxide, -sulfonate, -carbonyl, -oxalyl, -amidoxalyl, -hydrazidoxalyl, -carboxyl and esters and salts thereof, -amidyl, -hydrazidyl, nitrile.

Preferably, the enhancer has the formula:

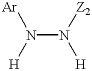

wherein Z₂ is as defined before and Ar is an optionally substituted aromatic or heteroaromatic group e.g. phenyl, phenyl substituted with halogen(s), alkoxy, alkyl, (alkyl)amino substituents, pyridinyl, alkyl-pyridinyl, furanyl. Especially preferred enhancer compounds have the generic structures:

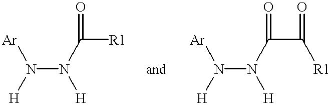

wherein the Ar group is as defined before and R1 is an optionally substituted alkyl, oxyalkyl, aryl, arylhydrazide, arylhydrazine or oxyaryl group.

Of particular interest are derivatives of 2′-phenylbenzohydrazide, having the following structure:

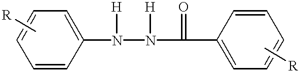

2-phenylhydrazide oxalate, having the following structure:

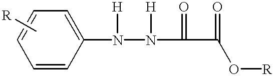

and oxalic acid bis(2-phenylhydrazide), having the following structure:

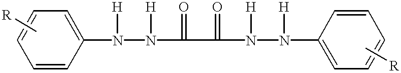

with R representing one or more substitutions independently selected from hydrogen, halogen(s), alkoxy, alkyl, (alkyl)amino, carbonate, carbonate ester, sulphonate, sulphonamide. Examples of such preferred compounds are:

2′-phenylbenzohydrazide

2′-m-tolylbenzohydrazide

2′-p-tolylbenzohydrazide

2′-o-tolylbenzohydrazide

Ethyl[2-(m-tolyl)]hydrazide oxalate

Ethyl[2-(p-tolyl)]hydrazide oxalate

Ethyl[2-(o-tolyl)]hydrazide oxalate

Oxalic acid bis(2-phenylhydrazide)

Oxalic acid bis(2-m-tolylhydrazide)

Oxalic acid bis(2-o-tolylhydrazide)

The enhancers used in the present invention can usefully be added to compositions in any suitable form, i.e. the form of a granular composition, a liquid or a slurry of the enhancer, with carrier, or a coating.

d. Compositions for Oxidizing Substances

Composition for oxidizing substances can be useful for several industrial applications. The present invention is of particular use for pulp bleaching, water purification, or denim bleaching in the textile industry. Also in hair dyeing formulations, the current composition can be useful. In all those applications, the use of effective peroxidase enzyme enhancers, without the necessity of adding hydrogen peroxide, can allow novel and cost-effective industrial processes. The compositions used in the process according to the invention are essentially free from hydrogen peroxide and compounds capable of generating hydrogen peroxide. Preferably, they will comprise less than 1 mM hydrogen peroxide, more preferably less than 0.1 mM, less than 0.01 mM, 0.001 mM or even less than 0.0001 mM hydrogen peroxide. Of further particular interest are detergent compositions, as described below in more detail.

e. Detergent Compositions

Detergent compositions according to the present invention are essentially free from hydrogen peroxide and compounds capable of generating hydrogen peroxide. Since the process of the invention employs hydrogen peroxide-free compositions or compositions with hydrogen peroxide concentrations of less than 1 mM, more preferably less than 0.1 mM, 0.01 mM, 0.001 mM or even less than 0.0001 mM, the detergent compositions according to the invention will be essentially hydrogen peroxide-free or comprising less than 0.1%, 0.01%, 0.001% hydrogen peroxide by weight or less.

The detergent compositions of the invention may take any suitable physical form, such as a powder, a tablet, an aqueous or non-aqueous liquid, a paste or a gel. However, granular detergents (powders) are preferred. A detergent composition may comprise the following ingredients, without pretending to be exhaustive.

A. Surfactants

When used to formulate bleaching detergent compositions, the compositions of the invention will contain one or more detergent-active compounds (surfactants) which may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch.

The preferred detergent-active compounds that can be used are soaps and synthetic non-soap anionic and nonionic compounds. Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulpho-succinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 (and preferably 3 to 7) moles of ethylene oxide per mole of alcohol. Non-ethoxylated nonionic surfactants include alkylpolyglycosides, glycerol monoethers, and polyhydroxy-amides (glucamide). If the detergent composition comprises both nonionic and anionic surfactants, it is preferred that the ratio of nonionic surfactant to anionic surfactant is at least 1 to 3, more preferably at least 1 to 1.

The choice of detergent-active compound (surfactant), and the amount present, will depend on the intended use of the detergent composition. In fabric washing compositions, different surfactant systems may be chosen, as is well known to the skilled formulator, for handwashing products and for products intended for use in different types of washing machine.

The total amount of surfactant present will also depend on the intended end use and may be as high as 60% by weight, for example, in a composition for washing fabrics by hand. In compositions for machine washing of fabrics, an amount of from 5 to 40% by weight is generally appropriate. Detergent compositions suitable for use in most automatic fabric washing machines generally contain anionic non-soap surfactant, or nonionic surfactant, or combinations of the two in any ratio, optionally together with soap.

B. Detergency Builders

The enzymatic bleach compositions of the invention will generally also contain one or more detergency builders. This detergency builder may be any material capable of reducing the level of free calcium ions in the wash liquor and will preferably provide the composition with other beneficial properties such as the generation of an alkaline pH, the suspension of soil removed from the fabric and the suspension of the fabric-softening clay material. The total amount of detergency builder in the compositions will suitably range from 5 to 80%, preferably from 10 to 60% by weight. Inorganic builders that may be present include sodium carbonate, if desired in combination with a crystallisation seed for calcium carbonate, as disclosed in GB-A-1 437 950 (Unilever); crystalline and amorphous aluminosilicates, for example, zeolites as disclosed in GB-A-1 473 201 (Henkel), amorphous aluminosilicates as disclosed in GB-A-1 473 202 (Henkel) and mixed crystalline/amorphous aluminosilicates as disclosed in GB-A-1 470 250 (Procter & Gamble); and layered silicates as disclosed in EP-B-164 (Hacksawed). Inorganic phosphate builders, for example, sodium orthophosphate, pyrophosphate and tripolyphosphate, may also be present, but on environmental grounds those are no longer preferred.

The detergent compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50% by weight. The alkali metal aluminosilicate may be either crystalline or amorphous or mixtures thereof, having the general formula:

0.8-1.5 Na₂O. Al₂O₃. 0.8-6SiO₂

These materials contain some bound water and are required to have a calcium ion exchange capacity of at least 50 mg CaO/g. The preferred sodium aluminosilicates contain 1.5-3.5 SiO₂ units (in the formula above) . Both the amorphous and the crystalline materials can be prepared readily by reaction between sodium silicate and sodium aluminate, as amply described in the literature. Suitable crystalline sodium aluminosilicate ion-exchange detergency builders are described, for example, in GB-A-1 429 143 (Proctor & Gamble). The preferred sodium aluminosilicates of this type are the well-known commercially available zeolites A and X, and mixtures thereof. The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP-A-384 070 (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20. Especially preferred is zeolite MAP having a silicon to aluminium ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di- and trisuccinates, carboxymethyloxysuccinates, carboxymethyl-oxymalonates, dipicolinates, hydroxyethyl-iminodiacetates, alkyl- and alkenylmalonates and succinates; and sulphonated fatty acid salts.

Especially preferred organic builders are citrates, suitably used in amounts of from 5 to 30% by weight, preferably from 10 to 25% by weight, and acrylic polymers, more especially acrylic/maleic copolymers, suitably used in amounts of from 0.5 to 15%, preferably from 1 to 10% by weight. Builders, both inorganic and organic, are preferably present in the form of their alkali metal salt, especially their sodium salt.

C. Additional Enzymes

The bleaching detergent compositions of the present invention may additionally comprise one or more enzymes, which provide cleaning performance, fabric care and/or sanitation benefits. Such enzymes include oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press. The most recent information on the nomenclature of enzymes is available on the Internet through the ExPASy WWW server (http://www.expasy.ch/)

Examples of the hydrolases are carboxylic ester hydrolase, thiolester hydrolase, phosphoric monoester hydrolase, and phosphoric diester hydrolase which act on the ester bond; glycosidase which acts on O-glycosyl compounds; glycosylase hydrolysing N-glycosyl compounds; thioether hydrolase which acts on the ether bond; and exopeptidases and endopeptidases which act on the peptide bond. Preferable among them are carboxylic ester hydrolase, glycosidase and exo- and endopeptidases. Specific examples of suitable hydrolases include (1) exopeptidases such as aminopeptidase and carboxypeptidase A and B and endopeptidases such as pepsin, pepsin B, chymosin, trypsin, chymotrypsin, elastase, enteropeptidase, cathepsin B, papain, chymopapain, ficain, thrombin, plasmin, renin, subtilisin, aspergillopepsin, collagenase, clostripain, kallikrein, gastricsin, cathepsin D, bromelain, chymotrypsin C, urokinase, cucumisin, oryzin, proteinase K, thermomycolin, thermitase, lactocepin, thermolysin, bacillolysin. Preferred among them is subtilisin; (2) glycosidases such as α-amylase, β-amylase, glucoamylase, isoamylase, cellulase, endo-1,3(4)-β-glucanase (β-glucanase), xylanase, dextranase, polygalacturonase (pectinase), lysozyme, invertase, hyaluronidase, pullulanase, neopullulanase, chitinase, arabinosidase, exocellobiohydrolase, hexosaminidase, mycodextranase, endo-1,4-β-mannanase (hemicellulase), xyloglucanase, endo-β-galactosidase (keratanase), mannanase and other saccharide gum degrading enzymes as described in WO-A-99/09127. Preferred among them are α-amylase and cellulase; (3) carboxylic ester hydrolase including carboxylesterase, lipase, phospholipase, pectinesterase, cholesterol esterase, chlorophyllase, tannase and wax-ester hydrolase. Preferred among them is lipase.

Examples of transferases and ligases are glutathione S-transferase and acid-thiol ligase as described in WO-A-98/59028 and xyloglycan endotransglycosylase as described in WO-A-98/38288.

Examples of lyases are hyaluronate lyase, pectate lyase, chondroitinase, pectin lyase, alginase II. Especially preferred is pectolyase, which is a mixture of pectinase and pectin lyase.

A different process for enhancing the efficacy of the bleaching action of oxidoreductases is by targeting them to stains by using antibodies or antibody fragments as described in WO-A-98/56885. Antibodies can also be added to control enzyme activity as described in WO-A-98/06812.

A preferred combination is a detergent composition comprising of a mixture of conventional detergent enzymes such as protease, amylase, lipase, cutinase and/or cellulase together with one or more plant cell wall degrading enzymes.

Endopeptidases (proteolytic enzymes or proteases) of various qualities and origins and having activity in various pH ranges of from 4-12 are available and can be used in the instant invention. Examples of suitable proteolytic enzymes are the subtilisins, which can be obtained from particular strains of B. subtilis, B. lentus, B. amyloliquefaciens and B. licheniformis, such as the commercially available subtilisins Savinase™, Alcalase™, Relase™, Kannase™ and Everlase™ as supplied by Novo Industri A/S, Copenhagen, Denmark or Purafect™, PurafectOxP™ and Properase™ as supplied by Genencor International. Chemically or genetically modified variants of these enzymes are included such as described in WO-A-99/02632 pages 12 to 16 and in WO-A-99/20727 and also variants with reduced allergenicity as described in WO-A-99/00489 and WO-A-20 99/49056.

Suitable lipases include those of bacterial or fungal origin as described in WO-A-99/11770 pages 33, 34, such as the commercially available Lipolase™, Lipolase Ultra™, LipoPrime™, from Novo Nordisk, or Lipomax™ from Genencor. Chemically or genetically modified variants of these enzymes are included.

Suitable amylases include those of bacterial or fungal origin. Chemically or genetically modified variants of these enzymes are included as described in WO-A-99/02632 pages 18, 19. Commercial cellulase are sold under the tradename Purastar™, Purastar OxAm™ (formerly Purafact Ox Am™) by Genencor; Termamyl™, Fungamyl™ and Duramyl™, all available from Novo Nordisk A/S.

Suitable cellulases include those of bacterial or fungal origin. Chemically or genetically modified variants of these enzymes are included as described in WO-A-99/02632 page 17. Particularly useful cellulases are the endoglucanases such as the EGIII from Trichoderma longibrachiatum as described in WO-A-94/21801 and the E5 from Thermomonospora fusca as described in WO-A-97/20025. Endoglucanases may consist of a catalytic domain and a cellulose binding domain or a catalytic domain only. Preferred cellulolytic enzymes are sold under the tradename Carezyme™, Celluzyme™ and Endolase™ by Novo Nordisk A/S; Puradax™ is sold by Genencor and KAC™ is sold by Kao corporation, Japan.

Detergent enzymes are usually incorporated in an amount of 0.00001% to 2%, and more preferably 0.001% to 0.5%, and even more preferably 0.01% to 0.2% in terms of pure enzyme protein by weight of the composition. Detergent enzymes are commonly employed in the form of granules made of crude enzyme alone or in combination with other components in the detergent composition. Granules of crude enzyme are used in such an amount that the pure enzyme is 0.001 to 50 weight percent in the granules. The granules are used in an amount of 0.002 to 20 and preferably 0.1 to 3 weight percent. Granular forms of detergent enzymes are known as Enzoguard™ granules, prills, marumes or T-granules. Granules can be formulated so as to contain an enzyme protecting agent (e.g. oxidation scavengers) and/or a dissolution retardant material. Other suitable forms of enzymes are liquid forms such as the “L” type liquids from Novo Nordisk, slurries of enzymes in nonionic surfactants such as the “SL” type sold by Novo Nordisk and microencapsulated enzymes marketed by Novo Nordisk under the tradename “LDP” and “CC”.

The enzymes can be added as separate single ingredients (prills, granulates, stabilised liquids, etc. containing one enzyme) or as mixtures of two or more enzymes (e.g. cogranulates). Enzymes in liquid detergents can be stabilised by various techniques as for example disclosed in U.S. Pat. Nos. 4,261,868 and 4,318,818.

The detergent compositions of the present invention may additionally comprise one or more biologically active peptides such as swollenin proteins, expansins, bacteriocins and peptides capable of binding to stains.

D. Other Ingredients

The compositions of the invention may contain alkali metal, preferably sodium, carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/ maleate polymer, or sodium silicate. One preferred powder structurant is fatty acid soap, suitably present in an amount of from 1 to 5 wt %.

The detergent compositions according to the present invention may also comprise from 0. 001% to 10%, more preferably from 0.01% to 2%, more preferably from 0.05% to 1% by weight of polymeric dye transfer inhibiting agents. Said polymeric dye transfer inhibiting agents are normally incorporated into detergent compositions in order to inhibit the transfer of dyes from colored fabrics onto fabrics washed therewith. These polymers have the ability to complex or adsorb the fugitive dyes washed out of dyed fabrics before the dyes have the opportunity to become attached to other articles in the wash. Especially suitable polymeric dye transfer inhibiting agents are polyamine N-oxide polymers, copolymers of N-vinylpyrrolidone and N-vinylimidazole, polyvinylpyrrolidone polymers, polyvinyl-oxazolidones and polyvinylimidazoles or mixtures thereof.

Soil release agents useful in compositions of the present invention are conventionally copolymers or terpolymers of terephthalic acid with ethylene glycol and/or propylene glycol units in various arrangements. Examples of such polymers are disclosed in the commonly assigned U.S. Pat. Nos. 4, 116,885 and 4,711,730 and EP-A-272 033.

Other materials that may be present in detergent compositions of the invention include sodium silicate; anti-redeposition agents such as cellulosic polymers; inorganic salts such as sodium sulphate, lather control agents or lather boosters as appropriate, enzyme stabilizers, corrosion inhibitors, dyes, colored speckles, perfumes, suds depressants, germicides, anti-tarnishing agents, opacifiers, optical brighteners, foam controllers, and fabric softening compounds. This list is not intended to be exhaustive.

Detergent compositions of the invention may be prepared by any suitable method. Particulate detergent compositions are suitably prepared by spray-drying a slurry of compatible heat-insensitive ingredients, and then spraying on or postdosing those ingredients unsuitable for processing via the slurry. The skilled detergent formulator will have no difficulty in deciding which ingredients should be included in the slurry and which should not.

Particulate detergent compositions of the invention preferably have a bulk density of at least 400 g/l, more preferably at least 500 g/l. Such powders may be prepared either by post-tower densification of spray-dried powder, or by wholly non-tower methods such as dry mixing and granulation; in both cases a high-speed mixer/granulator may advantageously be used. Processes using high-speed mixer/granulators are disclosed, for example, in EP-A-340 013, EP-A-367 339, EP-A-390 251 and EP-A-420 317 (Unilever).

Several types or classes of substances one may wish to oxidize are indicated below:

A. Polypyrrolic Structures

Polypyrrolic structures, often coordinated to a metal, form one class of colored substances which occur in stains. Examples are heme or haematin in blood stain, chlorophyll as the green substance in plants, e.g. grass or spinach. Another example of a metal-free substance is bilirubin, a yellow breakdown product of heme.

B. Tannins, Polyphenols

Tannins are polymerised forms of certain classes of polyphenols. Such polyphenols are catechins, leuantocyanins, etc. (P. Ribéreau-Gayon, Plant Phenolics, Ed. Oliver & Boyd, Edinburgh, 1972, pp.169-198). These substances can be conjugated with simple phenols like e.g. gallic acids. These polyphenolic substances occur in tea stains, wine stains, banana stains, peach stains, etc. and are notoriously difficult to remove.

C. Carotenoids

(G. E. Bartley et al., The Plant Cell (1995), Vol 7, 1027-1038). Carotenoids are the colored substances which occur in tomato (lycopene, red), mango (β-carotene, orange-yellow). They occur in food stains (tomato) which are notoriously difficult to remove, especially on colored fabrics, when the use of chemical bleaching agents is not advised.

D. Anthocyanins

(P. Ribéreau-Gayon, Plant Phenolics, Ed. Oliver & Boyd, Edinburgh, 1972, 135-169). These substance are the highly colored molecules which occur in many fruits and flowers. Typical examples, relevant for stains, are berries, but also wine. Anthocyanins have a high diversity in glycosidation patterns.

E. Maillard Reaction Products

Upon heating of mixtures of carbohydrate molecules in the presence of protein/peptide structures, a typical yellow/brown colored substance arises. These substances occur for example in cooking oil and are difficult to remove from fabrics.

F. Dyes in Solution.

For the prevention of dye transfer from a colored piece of fabric to other garments during the wash, it valuable to specifically bleach the dye molecules in the wash solution. Several types of fabric dyes are used, and can therefore be envisaged to be a target for the oxidation process: e.g. sulphur dyes, vat dyes, direct dye, reactive dyes and azoic dyes.

The invention will now be further illustrated in the following, non-limiting Examples.

### EXAMPLE 1

### Bleaching of Tomato Stains

The potential of the enzymatic bleach system, consisting of a peroxidase enzyme and an enhancer, to bleach stains was assessed by washing cotton swatches soiled with tomato stains. The experiments were performed in 1 l beakers, to which 800 ml of wash solution were added. Purified peroxidase from Arthromyces ramosus was added to the wash solution, resulting in a final enzyme concentration of 50 μg/l. The enhancer was dosed at 250 μM. The following formulation, set at pH 10.5, was used as wash solution (2 g/l):

Detergent Composition:

| | |
|---|---|
| Linear Alkylbenzene Sulphonate | 24% |
| Sodium Tripolyphosphate | 14.5% |
| Soda ash | 17.5% |
| Sodium silicate | 8.0% |
| SCMC | 0.37% |
| Blue pigment | 0.02% |
| Moisture/salts | 34.6% |

The swatches were washed during 30 minutes at 30° C. After the wash, the swatches were tumble-dried and the reflectance spectra were measured using a Minolta spectrometer. The color differences between the swatch before and after the wash data were expressed in the CIELAB L*a*b* color space. In this color space, L* indicates lightness and a* and b* are the chromaticity coordinates. Color differences between two swatches are expressed as ΔE, which is calculated from the following equation:

ΔE=\sqrt{ΔL²+Δa²+Δb²}

The results, as ΔE values, are shown in Table 1 below:

TABLE 1
Stain bleach performance of the peroxidase/enhancer
system on tomato stains in the presence of the enzymatic
bleach system.

| Enhancer | ΔΕ |
|---|---|
| None | 6.5 |
| Propyl [2-phenyl]hydrazide oxalate | 9.8 |
| Ethyl [2-(3-chlorophenyl)]hydrazide oxalate | 7.8 |
| Methyl [2-phenyl]hydrazide oxalate | 9.8 |
| 2′-phenylbenzohydrazide | 7.4 |
| Ethanedioic acid, 2-[(4-aminophenyl) sulfonyl]- | 8.1 |
| hydrazide-2-phenylhydrazide | |

As can be seen from the ΔE values, the bleaching of the tomato stain is improved in the presence of the peroxidase enzyme and the enhancer, although no hydrogen peroxide was added.

### EXAMPLE 2

### Bleaching of Tomato Stains

Example 1 was repeated using various concentrations of enhancer. The enhancer (Ethanedioic acid, 2-[(4-amino-phenyl)sulfonyl]hydrazide-2-phenylhydrazide) was dosed as indicated in Table 2. The results, as ΔE values, are also shown-in Table 2.

TABLE 2
Stain bleach performance of the peroxidase/enhancer
system on tomato stains at various enhancer concentrations.

| Enhancer | Peroxidase | ΔΕ |
|---|---|---|
| None | None | 7.5 |
| 200 μM | None | 7.4 |
| None | 5 mg/l | 7.7 |
| 50 μM | 5 mg/l | 8.3 |
| 100 μM | 5 mg/l | 9.0 |
| 200 μM | 5 mg/l | 9.6 |

Again, as can be seen from the ΔE values, the bleaching of the tomato stain was improved in the presence of the peroxidase enzyme and the enhancer, although no hydrogen peroxide was added.

1. Enzymatic oxidation process wherein an oxidisable substance is reacted with (a) a peroxidase, (b) a compound which enhances the activity of the peroxidase and (c) molecular oxygen.

2. Process according to claim 1, wherein the compound which enhances the activity of the peroxidase has the formula: 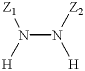
wherein Z₁ is any organic group e.g. (substituted)-(hetero)-(polycyclic)-aromatic, substituted (cyclo)-alkyl containing hetero atoms, and Z₂ is electron withdrawing group (as described in J. March, 'Advanced Organic Chemistry, pg 17, 3d ed. (1985)), selected from the group consisting of optionally substituted alkyl/(hetero)aryl- -sulfone, -sulfoxide, -sulfonate, -carbonyl, -oxalyl, -amidoxalyl, -hydrazidoxalyl, -carboxyl and esters and salts thereof, -amidyl, -hydrazidyl, nitrile.

3. Process according to claim 1, wherein the compound which enhances the activity of the peroxidase has the formula: 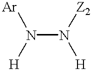
wherein Z₂ is as defined before and Ar is an optionally substituted aromatic or heteroaromatic group e.g. phenyl, phenyl substituted with halogen(s), alkoxy, alkyl, (alkyl)amino substituents, pyridinyl, alkyl-pyridinyl, furanyl, etc.

4. Process according to claim 1, wherein the compound which enhances the activity of the peroxidase has the formula: 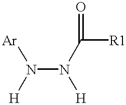
wherein Ar is as defined before and R1 is an optionally substituted alkyl, oxyalkyl, aryl, arylhydrazide or oxyaryl group.

5. Process according to claim 1, wherein the compound which enhances the activity of the peroxidase has the formula: 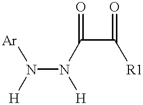
wherein Ar is as defined before and R1 is an optionally substituted alkyl, oxyalkyl, aryl, arylhydrazine or oxyaryl group.

6. Process according to claim 1, wherein the compound which enhances the activity of the peroxidase has the formula: 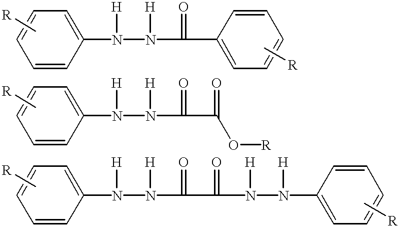
with R representing one or more substitutions independently selected from hydrogen, halogen(s), alkoxy, alkyl, (alkyl)amino, carbonate, carbonate ester, sulphonate, sulphonamide.

7. Process according to claim 1, wherein the compound which enhances the activity of the peroxidase is:
2′-phenylbenzohydrazide
2′-m-tolylbenzohydrazide
2′-p-tolylbenzohydrazide
2′-o-tolylbenzohydrazide
Ethyl[2-(m-tolyl)]hydrazide oxalate
Ethyl[2-(p-tolyl)]hydrazide oxalate
Ethyl[2-(o-tolyl)]hydrazide oxalate
Oxalic acid bis (2-phenylhydrazide)
Oxalic acid bis(2-m-tolylhydrazide)
Oxalic acid bis(2-o-tolylhydrazide)

8. Process according to claim 1, for bleaching stains on fabrics.

9. Process according to claim 1, wherein the substance which is to be oxidized is selected from the group consisting of porphyrin derived structures, tannins, polyphenols, carotenoids, anthocyanins, maillard reaction products and textile dyes.

10. A composition for oxidizing substances, comprising: (a) a peroxidase and (b) a compound which enhances the activity of the peroxidase, said composition being essentially free from hydrogen peroxide and compounds capable of generating hydrogen peroxide.

11. A composition for oxidizing substances according to claim 10, wherein the compound which enhances the activity of the peroxidase has the formula: 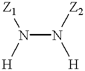
wherein Z₁ is any organic group e.g. (substituted)-(hetero)-(polycyclic)-aromatic, substituted (cyclo)-alkyl containing hetero atoms, and Z₂ is electron withdrawing group (as described in J. March, 'Advanced Organic Chemistry, pg 17, 3d ed. (1985)), selected from the group consisting of optionally substituted alkyl/(hetero)aryl- -sulfone, -sulfoxide, -sulfonate, -carbonyl, -oxalyl, -amidoxalyl, -hydrazidoxalyl, -carboxyl and esters and salts thereof, -amidyl, -hydrazidyl, nitrile.

12. A composition for oxidizing substances according to claim 10, wherein the compound which enhances the activity of the peroxidase has the formula: 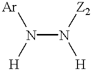
wherein Z₂ is as defined before and Ar is an optionally substituted aromatic or heteroaromatic group e.g. phenyl, phenyl having halogen(s), alkoxy, alkyl, (alkyl)amino substituents, pyridinyl, alkyl-pyridinyl, furanyl, etc.

13. A composition for oxidizing substances according to claim 10, wherein the compound which enhances the activity of the peroxidase has the formula: 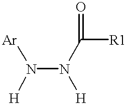
wherein Ar is as defined before and R1 is an optionally substituted alkyl, oxyalkyl, aryl, arylhydrazide or oxyaryl group.

14. A composition for oxidizing substances according to claim 10, wherein the compound which enhances the activity of the peroxidase has the formula: 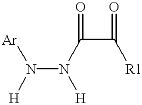
wherein Ar is as defined before and R1 is an optionally substituted alkyl, oxyalkyl, aryl, arylhydrazine or oxyaryl group.

15. A composition for oxidizing substances according to claim 10, wherein the compound which enhances the activity of the peroxidase has the formula: 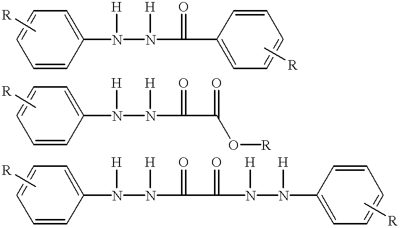
with R representing one or more substitutions independently selected from hydrogen, halogen(s), alkoxy, alkyl, (alkyl)amino, carbonate, carbonate ester, sulphonate, sulphonamide.

16. A composition for oxidizing substances according to claim 10, wherein the compound which enhances the activity of the peroxidase is selected from the group consisting of:
2′-phenylbenzohydrazide
2′-m-tolylbenzohydrazide
2′-p-tolylbenzohydrazide
2′-o-tolylbenzohydrazide
Ethyl[2-(m-tolyl)]hydrazide oxalate
Ethyl[2-(p-tolyl)]hydrazide oxalate
Ethyl[2-(o-tolyl)]hydrazide oxalate
Oxalic acid bis(2-phenylhydrazide)
Oxalic acid bis(2-m-tolylhydrazide)
Oxalic acid bis(2-o-tolylhydrazide)

17. Composition according to claim 10, wherein the substance which is to be oxidized is selected from the group consisting of porphyrin derived structures, tannins, polyphenols, carotenoids, anthocyanins and maillard reaction products.

18. A detergent composition for stain bleaching and/or anti dye-transfer, comprising: (a) a surfactant, (b) a peroxidase and (c) a compound which enhances the activity of the peroxidase, said composition being essentially free from hydrogen peroxide and compounds capable of generating hydrogen peroxide.

19. A detergent composition for stain bleaching and/or anti dye-transfer according to claim 18, wherein the compound which enhances the activity of the peroxidase has the formula: 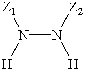
wherein Z₁ is any organic group e.g. (substituted)-(hetero)-(polycyclic)-aromatic, substituted (cyclo)-alkyl containing hetero atoms, and Z₂ is electron withdrawing group (as described in J. March, 'Advanced Organic Chemistry, pg 17, 3d ed. (1985)), selected from the group consisting of optionally substituted alkyl/(hetero)aryl- -sulfone, -sulfoxide, -sulfonate, -carbonyl, -oxalyl, -amidoxalyl, -hydrazidoxalyl, -carboxyl and esters and salts thereof, -amidyl, -hydrazidyl, nitrile.

20. A detergent composition for stain bleaching and/or anti dye-transfer according to claim 18, wherein the compound which enhances the activity of the peroxidase has the formula: 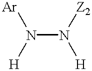
wherein Z₂ is as defined above and Ar is an optionally substituted aromatic or heteroaromatic group e.g. phenyl, phenyl substituted with halogen(s), alkoxy, alkyl, (alkyl)amino substituents, pyridinyl, alkyl-pyridinyl, furanyl, etc.

21. A detergent composition for stain bleaching and/or anti dye-transfer according to claim 18, wherein the compound which enhances the activity of the peroxidase has the formula: 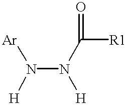
wherein Ar is as defined above and R1 is an optionally substituted alkyl, oxyalkyl, aryl, arylhydrazide or oxyaryl group.

22. A detergent composition for stain bleaching and/or anti dye-transfer according to claim 18, wherein the compound which enhances the activity of the peroxidase has the formula: 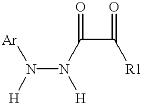
wherein Ar is as defined above and R1 is an optionally substituted alkyl, oxyalkyl, aryl, arylhydrazine or oxyaryl group.

23. A detergent composition for stain bleaching and/or anti dye-transfer according to claim 18, wherein the compound which enhances the activity of the peroxidase has the formula: 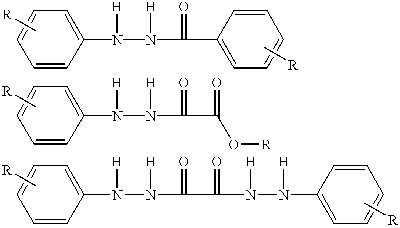
with R representing one or more substitutions independently selected from hydrogen, halogen(s), alkoxy, alkyl, (alkyl)amino, carbonate, carbonate ester, sulphonate, sulphonamide.

24. A detergent composition for stain bleaching and/or anti dye-transfer according to claim 18, wherein the compound which enhances the activity of the peroxidase is selected from the group consisting of:
2′-phenylbenzohydrazide
2′-m-tolylbenzohydrazide
2′-p-tolylbenzohydrazide
2′-o-tolylbenzohydrazide
Ethyl[2-(m-tolyl)]hydrazide oxalate
Ethyl[2-(p-tolyl)]hydrazide oxalate
Ethyl[2-(o-tolyl)]hydrazide oxalate
Oxalic acid bis(2-phenylhydrazide)
Oxalic acid bis(2-m-tolylhydrazide)
Oxalic acid bis(2-o-tolylhydrazide)
